(19) United States
(12) Patent Application Publication
(10) Pub. No.: US 2022/0111679 A1
(43) Pub. Date: Apr. 14, 2022

(54) AERODYNAMIC REMOVABLE WHEEL COVER

(71) Applicant: David Palmer, Houston, TX (US)

(72) Inventor: David Palmer, Houston, TX (US)

(21) Appl. No.: 17/120,628

(22) Filed: Dec. 14, 2020

Related U.S. Application Data
(60) Provisional application No. 63/090,207, filed on Oct. 10, 2020.

(51) Int. Cl. B60B 7/00; B60B 7/06; B60B 7/02

(52) U.S. Cl. CPC B60B 7/0013; B60B 7/02; B60B 7/063

(57) ABSTRACT

An improved wheel cover for large commercial vehicle trailers is disclosed. It includes simple and robust mechanism for attachment with the wheel, facilitates easy installation and removal, and provides better aerodynamics and fuel efficiency during travel. In a preferred embodiment, an annular flexible shell cover (covering an annular magnet) of the wheel cover, deforms and frictionally fits into hollow of a corresponding wheel flange, and the annular magnet (lying under the shell cover) keeps the shell cover magnetically attached (with a strong magnetic bonding) with the flange. Hence, in addition to the magnetic bonding, the installed wheel cover is held in place by a friction fitting between the shell cover and the flange. The outer side of the wheel cover can either be kept planar or curved, and its surface can be dimpled or smooth.

### TECHNICAL FIELD

This invention relates to wheel covers to the wheels of land vehicles, especially aerodynamic wheel covers for large commercial vehicle trailers, whereby the wheel covers improve aerodynamics and fuel efficiency.

### BACKGROUND

Usage of wheel covers in large commercial vehicle trailers such as tractor-trailers is not as prevalent as in cars and other smaller passenger vehicles.

In cars, owners generally do not need to access the axle nuts, lug nuts or other components frequently. So, installing and removing the hubcap (and wheel cover) on the wheel is not a frequent exercise.

In large commercial vehicles trailers, however, a driver, mechanic or operator may need to inspect or access the hub odometer, bearings, oil reservoir gauge, lug nuts, tire inflation valve, or some other wheel component frequently; thus requiring frequent removal and re-installation of wheel covers.

Moreover, whether it's a dual wheel or single wheel axle trailer, there is a substantial depth from the plane of the outer wheel rim inward to the region of the wheel hub where the wheel is attached to a brake drum, axle rotor, or the other wheel (for a dual wheel trailer). This characteristic in large commercial vehicle trailers makes it more difficult to secure a wheel cover.

Most of currently available wheel covers for large commercial vehicle trailers have one or more drawbacks such as they are either complex and time consuming to install (and remove), or are not flexible enough (i.e. are made of rigid metal or alloy) to lessen the damages caused during travel on accidental contacts in traffic. Still further, a rigid cover is prone to rattling, making noise, and coming loose due to vibrations during travel. Still further, many known wheel covers are constructed of a solid surface with no openings to allow for ventilation that may assist to cool and clean the hub area and adjacent brake components. Still further, such covers do not provide an effective exit means for mud and debris.

Some prior art methods of attaching a wheel cover to a truck wheel include a hub feature, such as a mounting bracket, that projects outwardly from the end of the wheel hub approximately to the plane of the wheel rim. However, these attachment methods require tools and significant labor for installation or removal, which is necessary to perform most repairs or maintenance on the wheels.

Furthermore, many of the prior art attachment systems are undesirably complex, either in the number of components required and/or the labor needed for installation and removal. The manufacturing costs of systems having a large number of components is also prohibitive at times.

Hence there is a need for an improved wheel cover which is easier to install, easier to remove, which is less complex, facilitates easy access to undercover wheel portions (such as hub area) and is commercially viable.

### SUMMARY

The invention is an improved wheel cover for wheels of large commercial vehicle trailers. Embodiments of the invention include simple and robust mechanism for attachment with the wheel, and facilitate easy installation and removal from it. Still further, during travel, embodiments of present invention provide better aerodynamics and fuel efficiency to large commercial vehicle trailers on which they are installed.

In a preferred embodiment, the wheel cover of the present invention is in the form of a disc whose diameter matches with that of a corresponding flange of the wheel. The wheel cover includes an outer side, an inner side, a flexible annular shell cover attached on the inner side and covering a magnetic component (i.e. an annular magnet), and a retrieval notch. The exposed surface of shell cover is contoured to fit into the hollow of the corresponding flange of the wheel.

When wheel cover is installed on the wheel, the shell cover deforms and frictionally fits into the hollow of the corresponding flange, and the annular magnet (lying under the shell cover) keeps the shell cover magnetically attached (with a strong magnetic bonding) with the flange. The magnets described herein can be iron, steel (or other iron alloys), rare, rare earth elements or alloys, ceramic (or ferrite) magnets, made of a sintered composite of powdered iron oxide and barium/strontium carbonate ceramic, and/or an AlNiCo magnet. The alloys can include one or more of: Nd₂Fe₁₄B (neodymium, preferably), SmCo₅, SmCo₇, SmFe₇, SmCu₇ and SmZr₇. Magnets can also be injection-molded magnets which are a composite of various types of resin and magnetic powders, or polymeric; e.g., using a high-coercivity ferromagnetic compound (usually ferric oxide) mixed with a plastic binder. Such magnets provide magnetic bonding to hold the installed wheel cover in place; in addition to the friction fitting between the shell cover and the flange.

For providing desired aerodynamics and improved fuel efficiency during travel, in various embodiments of the invention, the outer side of the wheel cover can either be kept planar or convex, and its surface can be dimpled or smooth.

### BRIEF DESCRIPTION OF DRAWINGS

FIG. 1A illustrates a perspective view of a wheel carrying a tire, of large commercial vehicle trailer.

FIG. 1B illustrates a perspective view of the wheel of FIG. 1A.

FIG. 1C illustrates an elevational view of the wheel illustrated in FIG. 1B.

FIG. 2A shows the outer side of a wheel cover in accordance with a first embodiment of the present invention.

FIG. 2B shows the inner side of the wheel cover in FIG. 2A.

FIG. 2C shows an elevational view of the outer side of the wheel cover in FIG. 2A.

FIG. 2D shows an elevational view of the inner side of the wheel cover in FIG. 2A.

FIG. 2E illustrates a cross-section of wheel cover of FIG. 2D taken along AA′ in FIG. 2D.

FIG. 3A is an exploded cross-sectional view of the wheel of FIG. 1B and the first embodiment of the wheel cover, positioned for assembly.

FIG. 3B is a cross-sectional view of the wheel and cover of FIG. 3A assembled.

FIG. 4A shows inner side view of a wheel cover in accordance with a second embodiment of the present invention.

FIG. 4B shows inner side view of a wheel cover in accordance with a third embodiment of the present invention.

FIG. 4C shows inner side view of a wheel cover in accordance with a fourth embodiment of the present invention.

FIG. 4D shows inner side view of a wheel cover in accordance with a fifth embodiment of the present invention.

FIG. 4E shows inner side view of a wheel cover in accordance with a sixth embodiment of the present invention.

FIG. 4F shows inner side view of a wheel cover in accordance with a seventh embodiment of the present invention.

FIG. 5A illustrates an elevational view of the outer side of the wheel cover of FIG. 4E.

FIG. 5B illustrates an elevational view of the inner side of the wheel cover of FIG. 4E.

FIG. 5C illustrates a cross-section of wheel cover of FIG. 5B taken along BB′ in FIG. 5B.

FIG. 5D. is an exploded cross-sectional view of the wheel of FIG. 1B and the sixth embodiment of the wheel cover, positioned for assembly.

FIG. 5E is a cross-sectional view of the wheel and cover of FIG. 5D assembled.

FIG. 6A shows inner side view of a wheel cover in accordance with an eighth embodiment of the present invention.

FIG. 6B shows inner side view of a wheel cover in accordance with a ninth embodiment of the present invention.

FIG. 6C shows an elevational view of the outer side of the wheel cover of FIG. 6B.

FIG. 6D shows an elevational view of the inner side of the wheel cover of FIG. 6B.

FIG. 6E illustrates a cross-section of wheel cover of FIG. 6D taken along CC′ in FIG. 6D.

FIG. 6F is an exploded cross-sectional view of the wheel of FIG. 1B and the ninth embodiment of the wheel cover, positioned for assembly.

FIG. 6G is a cross-sectional view of the wheel and cover of FIG. 6B assembled.

FIG. 7A illustrates a perspective view of a tenth embodiment of a wheel cover in accordance with the present invention.

FIG. 7B illustrate an elevational view of the outer side of the wheel cover of FIG. 7A.

FIG. 7C illustrates a cross-section of wheel cover of FIG. 7A taken along DD′ in FIG. 7B.

FIG. 7D shows a magnified view of portion U′W′V′X′ of FIG. 7C, in portion UWVX.

FIG. 7E is an exploded cross-sectional view of the wheel of FIG. 1B and the tenth embodiment of the wheel cover, positioned for assembly.

FIG. 7F is a cross-sectional view of the wheel and cover of FIG. 7C assembled.

FIG. 8A illustrates an elevational view of the outer side of an eleventh embodiment of a wheel cover in accordance with the present invention.

FIG. 8B illustrates an elevational side view of wheel cover of FIG. 8A.

FIG. 8C illustrates a cross-section of the tenth embodiment of a wheel cover taken along EE′ in FIG. 8A.

FIG. 8D shows a magnified view of portion M′N′P′Q′ of FIG. 8C, in portion MNPQ.

FIG. 8E is an exploded cross-sectional view of the wheel of FIG. 1B and the eleventh embodiment of the wheel cover, positioned for assembly.

FIG. 8F is a cross-sectional view of the wheel and cover of FIG. 8C assembled.

FIG. 9A illustrates an uncovered wheel carrying a tire of a large commercial vehicle trailer.

FIG. 9B illustrates a wheel carrying a tire of a large commercial vehicle trailer having the first embodiment of the wheel cover installed.

The drawings and the associated description below are intended and provided to illustrate one or more embodiments of the present invention, and not to limit the scope of the invention. Also, it should be noted that the drawings are not be necessarily drawn to scale.

### DETAILED DESCRIPTION

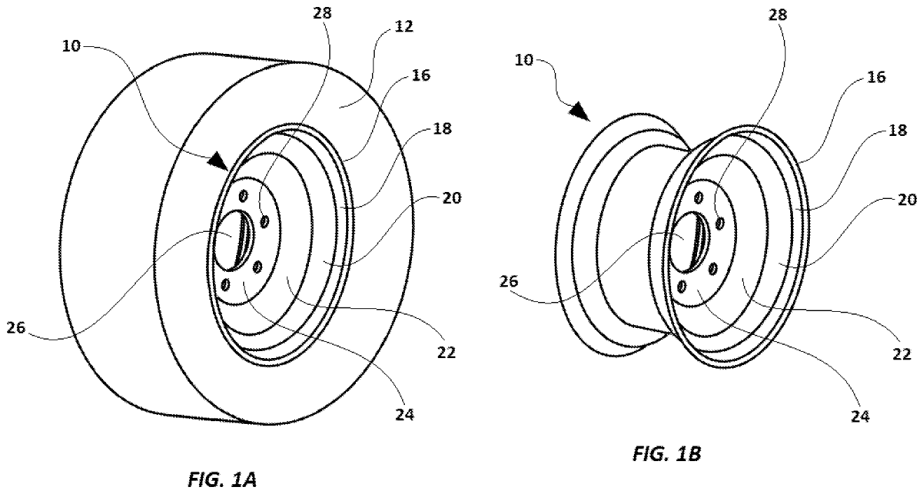

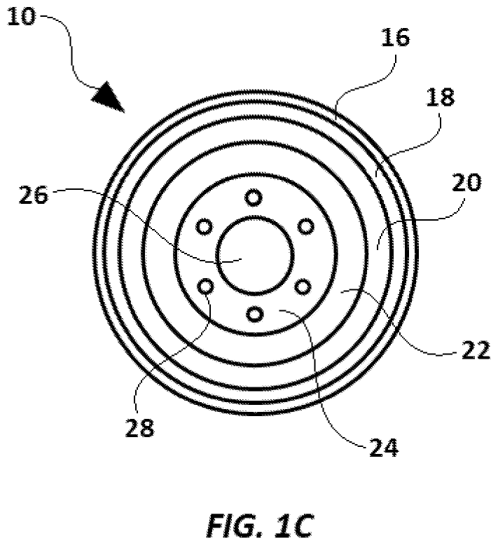

A first embodiment of the wheel cover in accordance with the present invention will now be described in conjunction with FIGS. 1A-C, 2A-D, and 3A-B. FIG. 1A illustrates a metallic wheel 10 carrying a tire 12 of a large commercial vehicle trailer on which wheel cover 100 would be installed. Wheel 10 is made of ferromagnetic metal such as steel or any other ferromagnetic alloy. As shown in FIGS. 1A, 1B and 1C, wheel 10 further includes an outer circular periphery 16 (i.e. rim of wheel 10), a first flange 18, a second flange 20, and a third flange 22, a central disc 24 with a central hole 26 (for the axle, not shown) and multiple apertures 28 (for axle bolts, not shown). Apart from the illustrated structure, obvious variations in structure of wheel 10 are possible. It should be noted that, scope of invention is not limited by the structure of wheel 10.

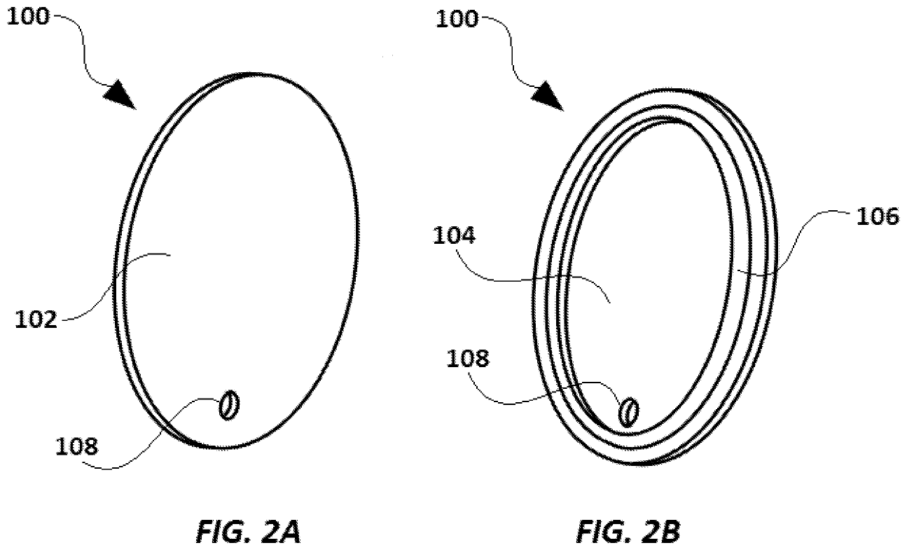

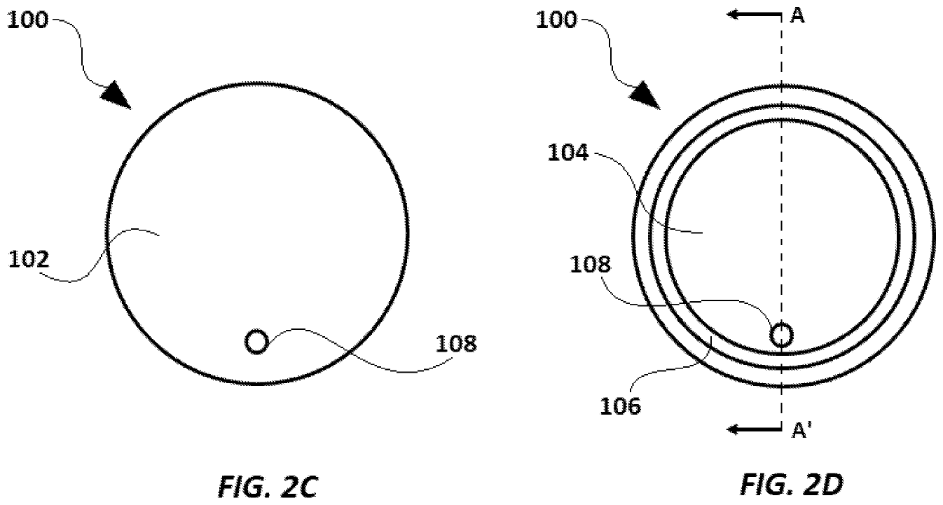

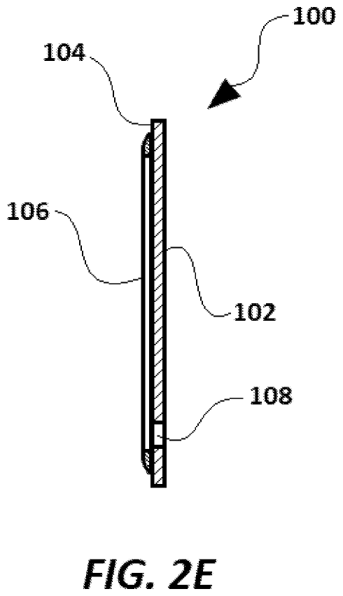

Wheel cover 100 is a circular disc. As illustrated FIGS. 2A-D, wheel cover 100 includes an outer side 102, an inner side 104, a magnetic component (i.e. an annular magnet 106), and an access hole 108. The annular magnet 106 exert a strong magnetic force, and is attached to the inner side 104. Both, the outer side 102 and the inner side 104 have planar surfaces.

The diameter of wheel cover 100 (which is also the diameter of outer side 102 and the inner side 104) matches with that of the outer circular periphery 16 of wheel 10. The exposed surface of annular magnet 106 is contoured to fit into the hollow of first flange 18.

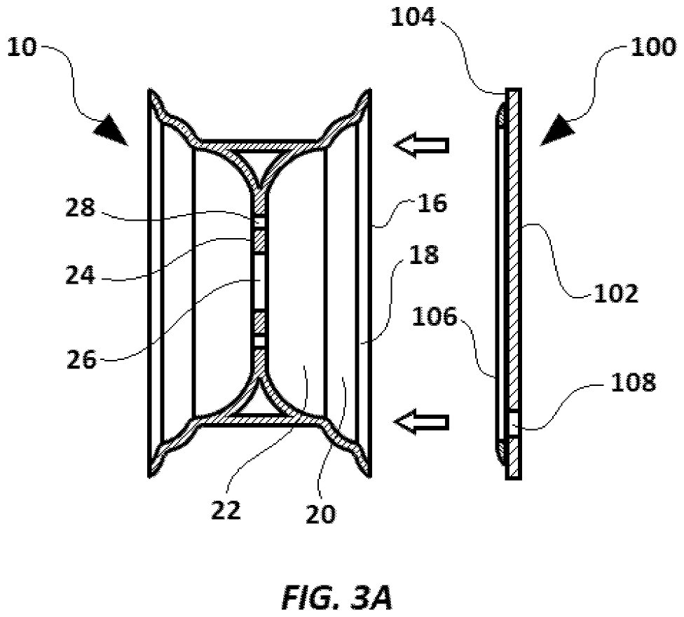

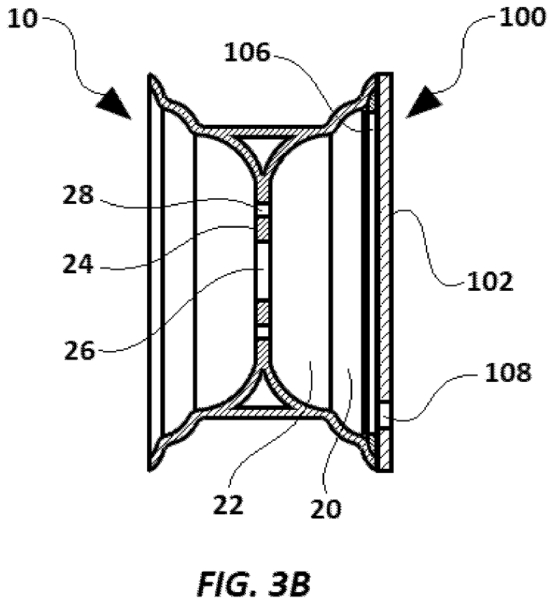

FIG. 3A is an exploded cross-sectional view of the wheel 10 and the wheel cover 100 (taken along AA′ illustrated in FIG. 2D). When wheel cover 100 is installed on the wheel 10, the annular magnet 106 fits into and gets magnetically attached (with a strong magnetic bonding) with the hollow of the first flange 18 (as shown in FIG. 3B). The thickness of wheel cover 100 (i.e. the thickness of portion of wheel cover 100 bound between the outer side 102 and the inner side 104) is selected such that, post installation, the outer side 102 preferably remains co-planar with sides of inflated tire 12.

Except the annular magnet 106, the entire wheel cover 100 is made of a robust but flexible plastic material (such as High-density-Poly-Ethylene or HDPE) or carbon fibre. This makes the wheel cover 100 lighter and less vulnerable to accidental breakdown damages in traffic. Further, being magnetically attached to the wheel 10, the wheel cover 100 facilitates easy installation (and detachment) of itself on the wheel 10. In an installed wheel cover 100, the access hole 108 can be made to serve multiple purposes. Firstly, it can be used to detach the wheel cover 100 from the wheel 10 simply by hands or any simple hook tool. Secondly, during its installation, if the access hole 108 is positioned in front of the air nozzle of tire 12, air pressure checks and maintenance can always be done without detaching the wheel cover 100. Thirdly, an appropriate size and position of the access hole 108 can assist in exit of debris which may get accumulated within hollow of wheel 10 over the time.

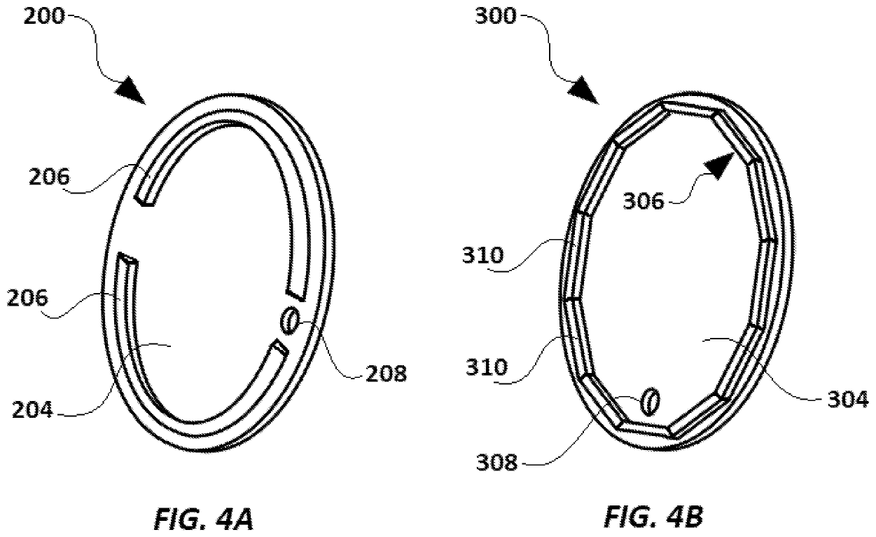

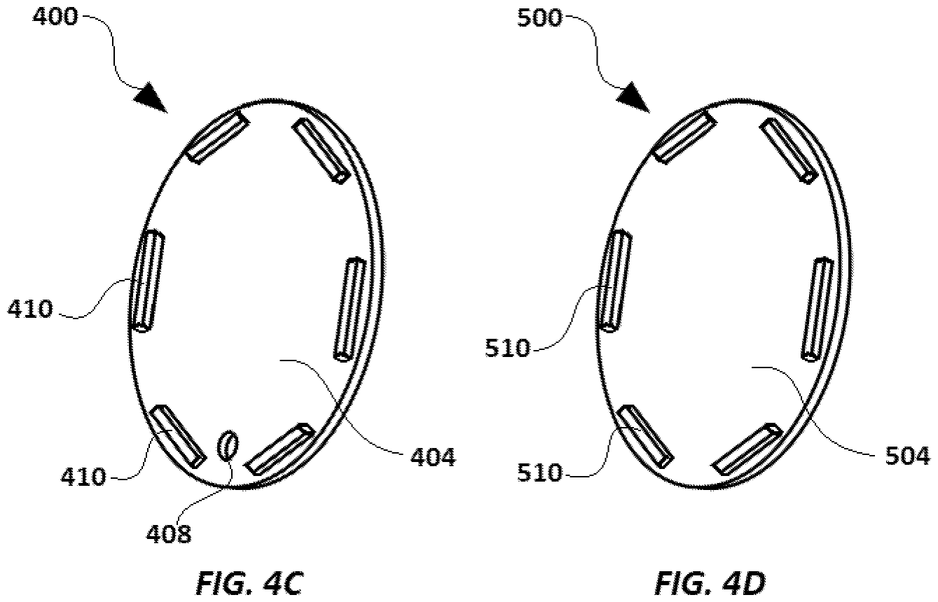

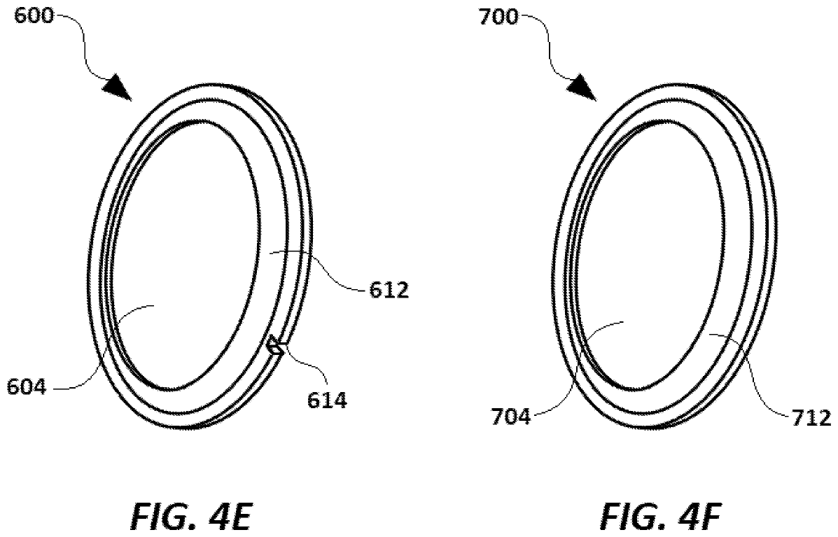

Perspective inner views of a second, third, fourth, fifth, sixth and seventh embodiment of the wheel cover of the present invention is illustrated in FIGS. 4A to 4F respectively.

The inner side view of second embodiment of the invention is shown in FIG. 4A. Wheel cover 200 (i.e. the second embodiment of the invention) includes an outer side 202 (which remains hidden in FIG. 4A), an inner side 204, and a magnetic component (i.e. two arc magnets 206). Both, the outer side 202 and the inner side 204 have planar surfaces. Arc magnets 206 exert a strong magnetic force, and are attached to the inner side 204. Wheel cover 200 is structurally and dimensionally similar to wheel cover 100, except that instead of an annular magnet 106 (as in wheel cover 100), the wheel cover 200 includes two arc magnets 206. Radial dimensions and surface contours of arc magnets 206 is similar to that of annular magnet 106. When wheel cover 200 is installed on the wheel 10, the arc magnets 206 fit into and get magnetically attached (with a strong magnetic bonding) with the hollow of the first flange 18.

Apart from being arc shaped and having a corresponding arc length (and not a complete circle), both arc magnets 206 have similar dimensions as their corresponding annular magnet 106 of wheel cover 100.

Similar to the wheel cover 100, the third and fourth embodiments (i.e. wheel covers 300 and 400, shown in FIGS. 4B and 4C) include outer side 302 and 402 (302 and 402 remain hidden in respective FIGS. 4B and 4C), inner side 304 and 404 and, access holes 308 and 408 respectively. The outer sides 302 and 402, and inner sides 304 and 404 have planar surfaces. The fifth embodiment of the invention (i.e. wheel cover 500, as shown in FIG. 4D) is similar to wheel cover 400, except that it does not includes an access hole. Wheel cover 500 includes an outer side 502 (is hidden in FIG. 4D) and inner side 504.

Except the structure of their respective magnetic components, the second embodiment, the third, fourth and fifth embodiments of the wheel cover are structurally and dimensionally similar to wheel cover 100. In detail, as shown in FIGS. 4B, 4C and 4D, in comparison to wheel cover 100, the third embodiment (i.e. the wheel cover 300) includes a magnetic ring 306 formed by an array of bar magnets 310 adjoining each other, and the fourth embodiment (i.e. the wheel cover 400) includes an array of bar magnets 410 arranged with a separation among each other in a circular manner. The array of bar magnets 510 of wheel cover 500 is similar to the array of bar magnets 410 of wheel cover 400. Since Bar magnets 310, 410 and 510 exert strong magnetic force, they do not have a contoured exposed surface matching with hollow of corresponding flange of wheel 10. Instead, only their contact with corresponding flange of wheel 10 is good enough to hold their corresponding wheel cover attached with wheel 10.

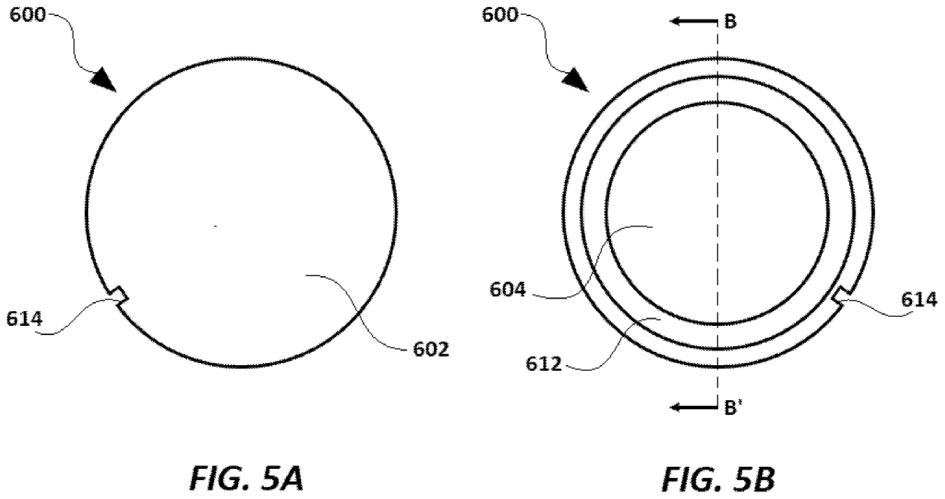

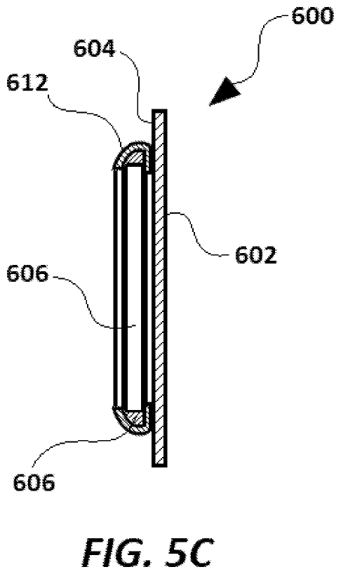

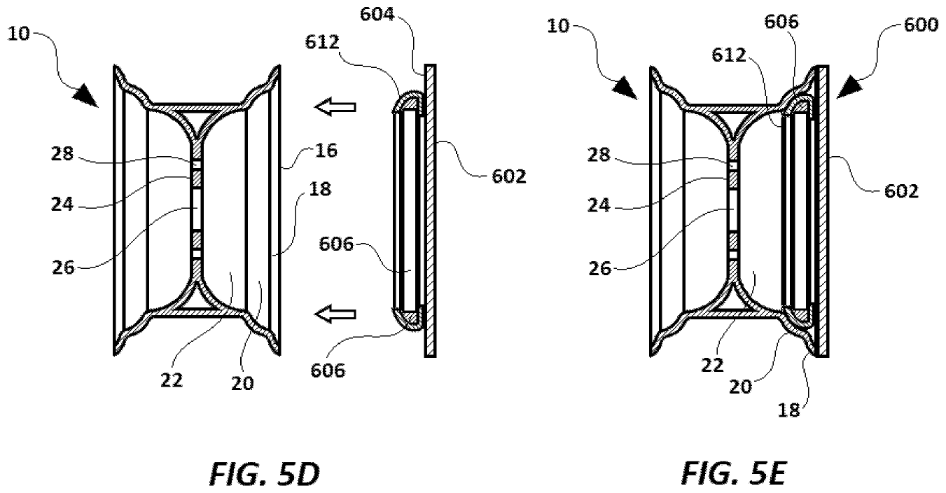

A sixth embodiment of the invention (i.e. wheel cover 600) will now be described in conjunction with FIGS. 4A, 5A-5E. Wheel cover 600 includes an outer side 602 (as in FIG. 5A), an inner side 604 (as in FIGS. 4E and 5B), a magnetic component (i.e. a strong annular magnet 606 visible in FIGS. 5C-E) covered under a flexible annular shell cover 612 (shell cover 612 being attached to the inner side 604), and a retrieval notch 614. Both, the outer side 602 and the inner side 604 have planar surfaces. Wheel cover 600 is structurally similar to wheel cover 100, except that the wheel cover 600 includes flexible annular shell cover 612 over the annular magnet 606, and instead of access hole 108, wheel cover includes the retrieval notch 614. A cross-section of wheel cover 600 of FIG. 5B taken along BB′ is illustrated in FIG. 5C.

The exposed surface of shell cover 612 is contoured to fit into the hollow of second flange 20 of wheel 10. Since the dimensions of the hollow space of second flange 20 is fixed, the cross-sectional dimensions (and contours) of the annular magnet 606 are suitably reduced to provide space for the shell cover 612.

When wheel cover 600 is installed on the wheel 10, as shown in FIGS. 5D and 5E, the shell cover 612 deforms and frictionally fits into the hollow of the second flange 20, and the annular magnet 606 (lying under the shell cover 612) keeps the shell cover 612 magnetically attached (with a strong magnetic bonding) with second flange 20. Hence, in addition to the magnetic bonding, the installed wheel cover 600 is held in place by a friction fitting between the shell cover 612 and the second flange 20 (as shown in FIG. 5E).

The seventh embodiment of the invention, (i.e. wheel cover 700) is illustrated in FIG. 4F. Wheel cover 700 (along with all its illustrated corresponding components) is similar to wheel cover 600, except that it does not include a retrieval notch (i.e. notch 614 of wheel cover 600).

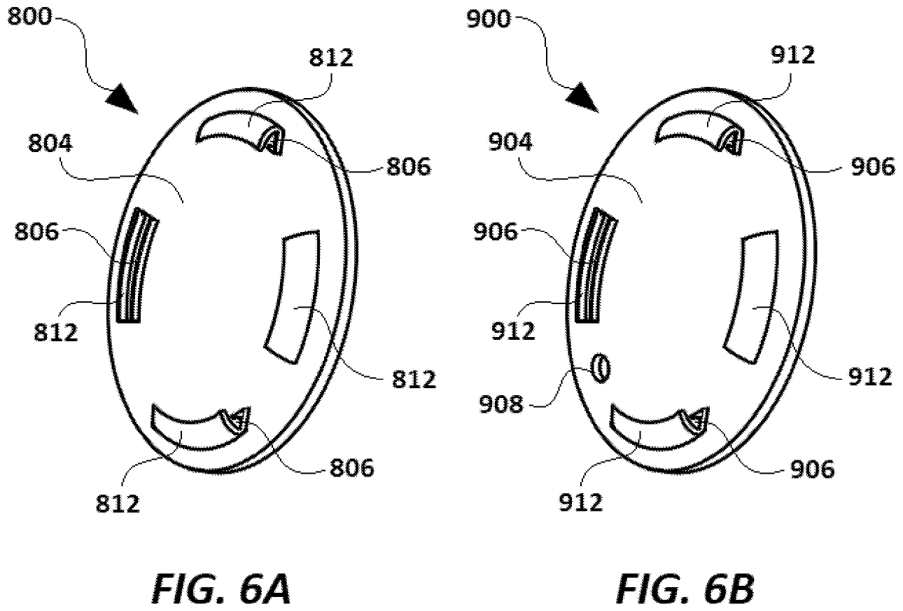

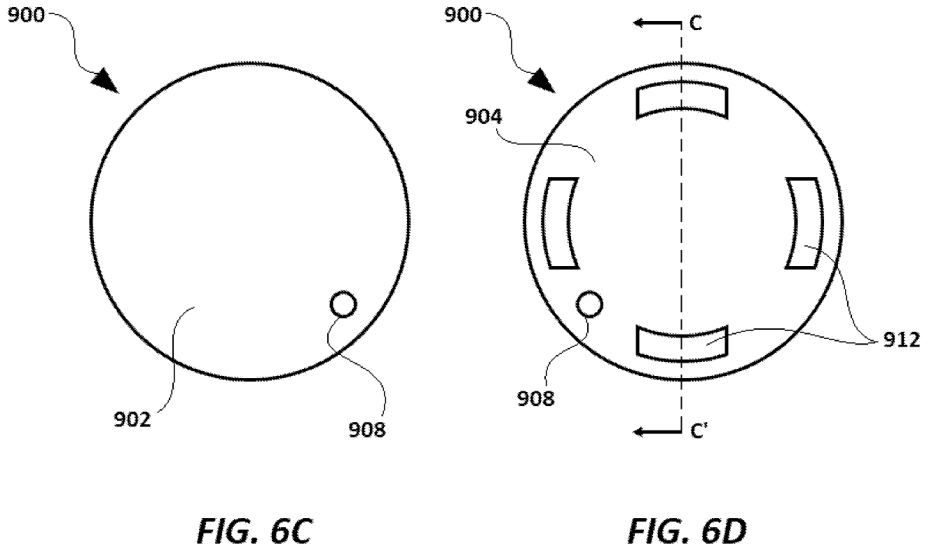

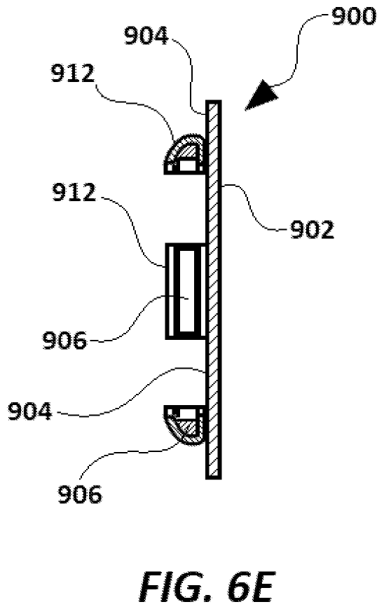

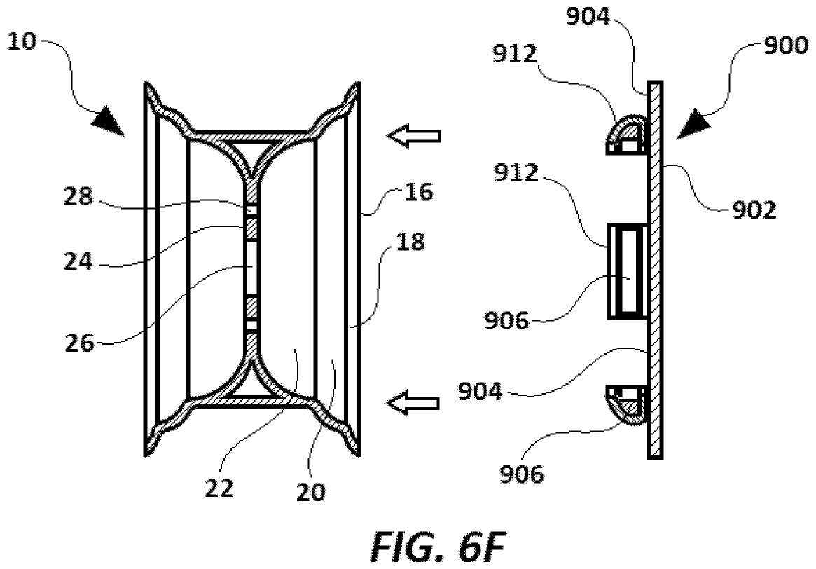

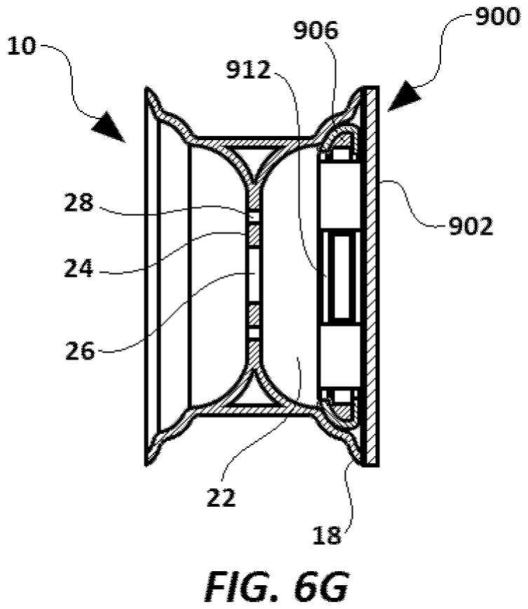

Eighth and ninth embodiments of the present invention are further modifications of wheel cover 600. The Eighth embodiment, i.e. wheel cover 800, as shown in FIG. 6A, is structurally and dimensionally similar to wheel cover 600, except that instead of having a magnetic component such as an annular magnet 606 and the shell cover 612, wheel cover 800 includes four arc magnets 806, and each arc magnet 806 is covered under its respective flexible arc shaped shell cover 812, and that wheel cover 800 does not include notch 614. Apart from being arc shaped and having a suitable a corresponding arc length (and not a complete ring), all the four arc magnets 806 and their corresponding shell covers 812 have similar dimensions as their corresponding annular magnet 606 and shell cover 612 of wheel cover 600.

Similarly, the ninth embodiment, i.e. wheel cover 900 (along with all its illustrated corresponding components), as shown in FIG. 6B-6E, is structurally similar to wheel cover 800, except that wheel cover 900 includes an access hole 908. Wheel cover 800 and 900 include an outer side 802 (which remains hidden in FIG. 6A), 902 (shown in FIG. 6C), and inner side 804 and 904 respectively. The outer sides 802 and 902, and inner sides 804 and 904 have planar surfaces. Installation of wheel covers 800 and 900 is similar to that of wheel cover 600 described above.

FIG. 6F is an exploded cross-sectional view of the wheel 10 and the wheel cover 900 (taken along CC′ illustrated in FIG. 6D). When wheel cover 900 is installed on the wheel 10, the shell covers 912 frictionally fit into the hollow of the second flange 20, and the corresponding annular magnets 906 (lying under the shell cover 912) keep the shell cover 912 magnetically attached (with a strong magnetic bonding) with second flange 20. Hence, in addition to the magnetic bonding, the installed wheel cover 900 is held in place by a friction fitting between the shell cover 912 and the second flange 20 (as shown in FIG. 6G).

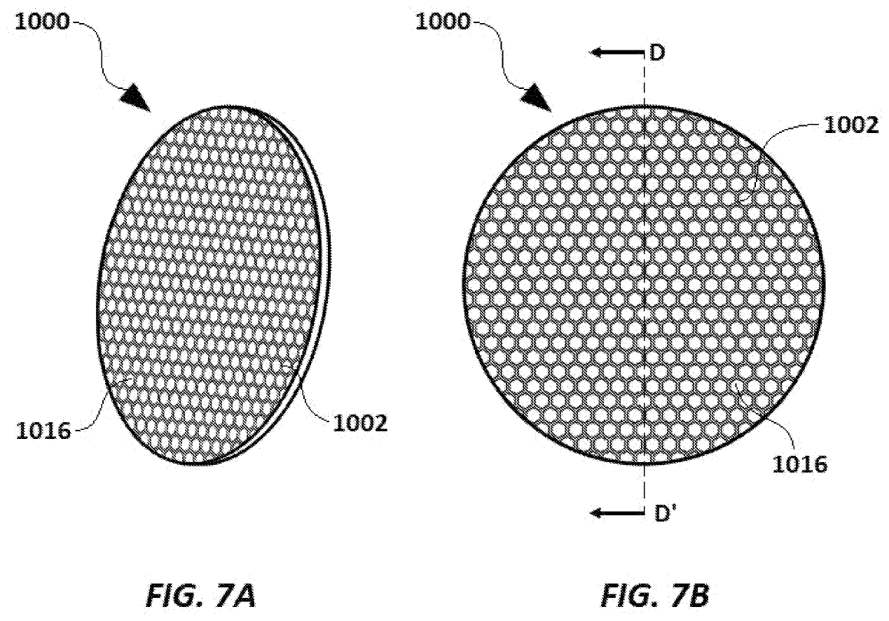

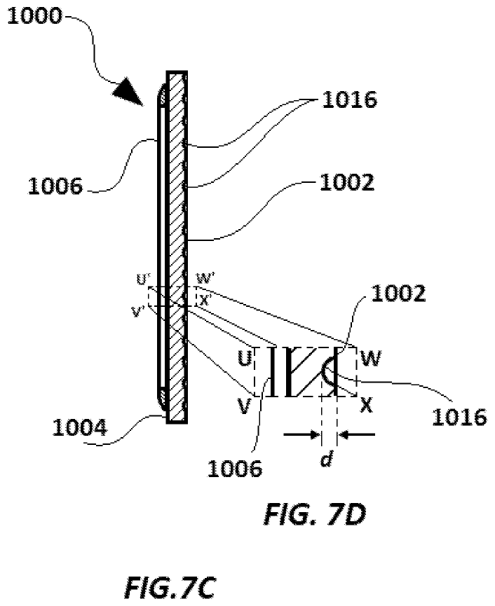

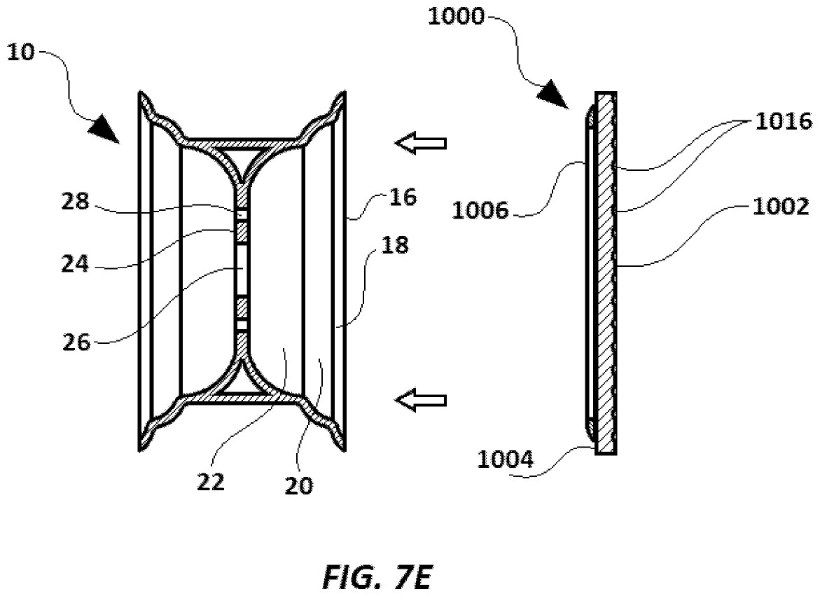

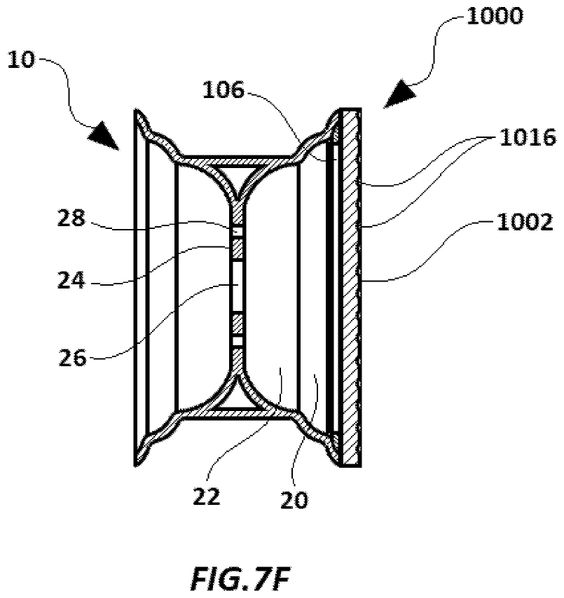

The Tenth embodiment of wheel cover (i.e. wheel cover 1000) of invention is described in conjunction with FIGS. 7A-7E. Wheel cover 1000 is structurally and dimensionally similar to wheel cover 100, except that the outer side 1002, as shown, has a dimpled surface formed by an array of connected hexagonal dimples. A cross-sectional view of wheel cover 1000 taken along line DD′ in FIG. 7B is illustrated in FIG. 7C. Each hexagon 1016 in the array of hexagonal dimples includes a hemispherical dimple (or depression). A magnified view of cross-section of a hemispherical dimple in portion U′W′V′X′ of FIG. 7C is illustrated in portion UWVX of FIG. 7D. Similar to wheel cover 100, wheel cover 1000 includes an inner side 1004 (remains hidden in FIGS. 7A and 7B), and a magnetic component (i.e. an annular magnet 1006) attached inner side 1004. Annular magnet 1006 remains hidden in FIGS. 7A and 7B, and is visible in cross-sections of FIGS. 7C, 7D, 7E and 7F. Note that for clarity of illustration, the number of hexagons illustrated in cross-section of FIG. 7C is reduced. The outer side 1002 (along with the hexagonal array) and inner side 1004 have planar surfaces.

As a result of array of hexagonal dimples on outer side 1002, during travel, any vehicle with wheel cover 1000 installed, achieves better aerodynamics, experiences reduced air resistance and achieves better fuel efficiency.

Installation of wheel cover 1000 on the wheel 10 is similar to that of wheel cover 100. FIG. 7E is an exploded cross-sectional view of the wheel 10 and the wheel cover 1000 (of FIG. 7C). The annular magnet 1006 fits into and gets magnetically attached (with a strong magnetic bonding) with the hollow of the first flange 18 (as shown in FIG. 7F).

Each hexagon 1016 is a regular hexagon (i.e. having equal sides and equal interior angles). Dimensions of each hexagon 1016 of the array and depth of dimple within each hexagon (illustrated as ‘d’ in FIG. 7D) are chosen suitably based on the overall dimensions of the wheel cover and desired aerodynamics for achieving reduced air resistance and improved fuel efficiency during travel.

Preferably, diameter of a circle circumscribing each hexagon is equal to 1/90th of diameter of rim (i.e. of circular periphery 16) of wheel 10, and depth ‘d’ (illustrated in FIG. 7D) is equal to 1/2250^{th} of diameter of rim (i.e. of circular periphery 16) of wheel 10.

For example, for a wheel rim having diameter of 22.50 inches, corresponding diameter of a circle circumscribing each hexagon 1016 would be (( 1/90)×(22.50))=0.25 inches, and depth ‘d’ would be (( 1/2250)×(22.50))=0.01 inches.

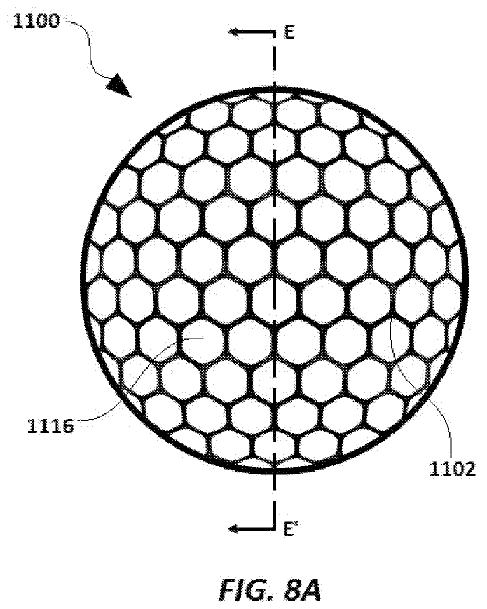

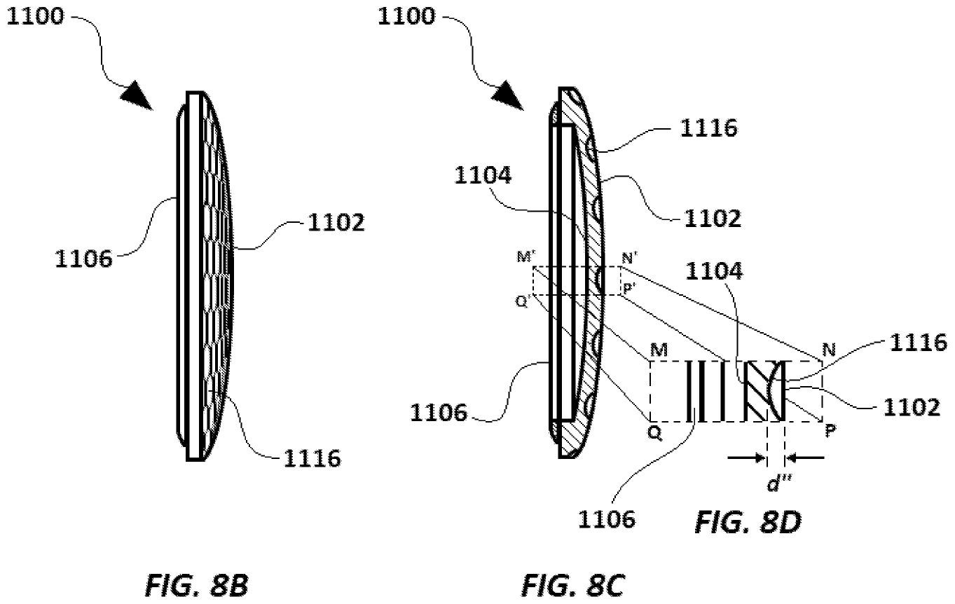

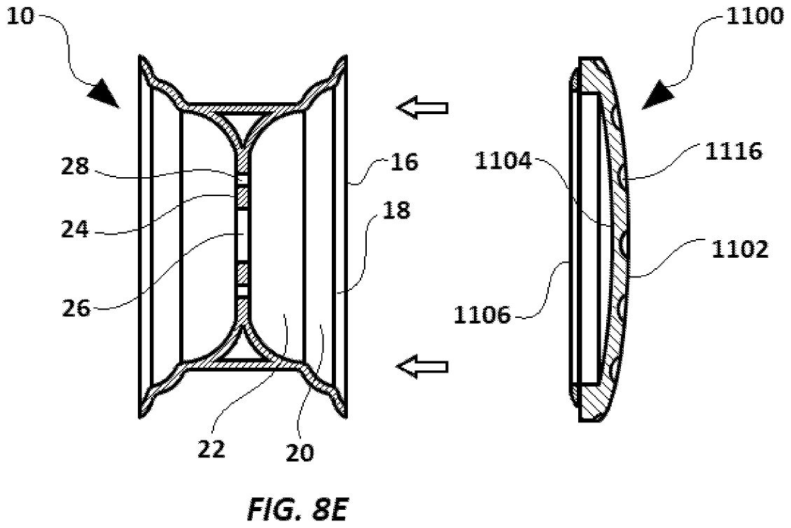

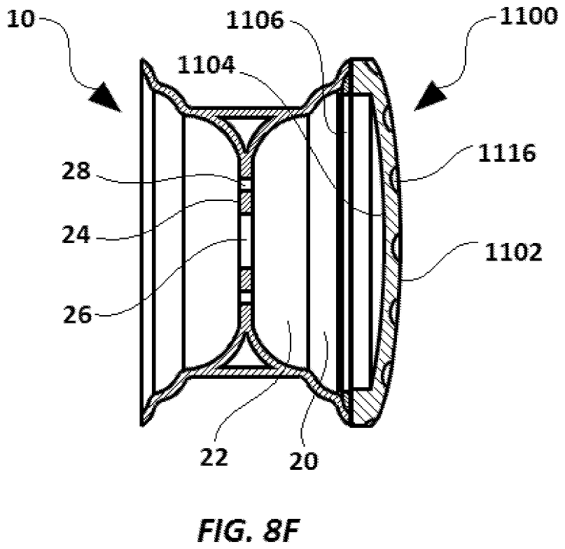

The eleventh embodiment of wheel cover (i.e. wheel cover 1100) of invention is described in conjunction with FIGS. 8A-8F. Wheel cover 1100 (along with all its illustrated corresponding components) is structurally and dimensionally similar to wheel cover 100, except that the outer side 1102 has a curved surface so that its convex when in position, and the surface includes an array of connected hexagonal dimples. Each hexagon 1116 in the array includes a hemispherical dimple. It is to be noted that outer sides of alternate embodiments of the invention may have concave surface or any other type of curved surface.

A cross-sectional view of wheel cover 1100 taken along line EE′ in FIG. 8A is illustrated in FIG. 8C. Each hexagon 1116 in the array of hexagonal dimples includes a hemispherical dimple (or depression). A magnified view of the hemispherical dimple in portion M′N′P′Q′ of FIG. 8C is illustrated in portion MNPQ of FIG. 8D). Similar to wheel cover 100, wheel cover 1100 includes an inner side 1104 (remains hidden in FIG. 8A), and a magnetic component (i.e. an annular magnet 1106). The annular magnet 1106 is attached inner side 1104. Annular magnet 1106 remains hidden in FIG. 8A, and is visible in FIGS. 8B, 8C, 8D, 8E and 8F) attached inner side 1104. The inner side 1104 has a planar surface. Note that annular magnet 1106 remains hidden in illustrations of FIG. 8A.

Installation of wheel cover 1100 on the wheel 10 is similar to that of wheel cover 100. FIG. 8E is an exploded cross-sectional view of the wheel 10 and the wheel cover 1100 (of FIG. 8C). The annular magnet 1106 fits into and gets magnetically attached (with a strong magnetic bonding) with the hollow of the first flange 18 (as shown in FIG. 8F)

As a result of array of hexagonal dimples on a convex surface of outer side 1102, during travel, any vehicle with wheel cover 1100 installed, achieves better aerodynamics, experiences reduced air resistance and achieves better fuel efficiency.

Each hexagon 1116 is a regular hexagon (i.e. having equal sides and equal interior angles). Dimensions of curved surface of the outer side 1102, each hexagon 1116 of the array, and depth of dimple within each hexagon (illustrated as ‘d″’ in FIG. 8D) are chosen suitably based on the overall dimensions of the wheel cover and desired aerodynamics for achieving reduced air resistance and improved fuel efficiency during travel.

Preferably, diameter of a circle circumscribing each hexagon 1116 is equal to 1/90^{th} of diameter of rim (i.e. of circular periphery 16) of wheel 10, and depth ‘d″’ (illustrated in FIG. 7D) is equal to 1/2250th of diameter of rim (i.e. of circular periphery 16) of wheel 10.

For example, for a wheel rim having diameter of 22.50 inches, corresponding diameter of a circle circumscribing each hexagon 1116 would be (( 1/90)×(22.50))=0.25 inches, and depth ‘d″’ would be (( 1/2250)×(22.50))=0.01 inches.

Though tenth and eleventh embodiment of the invention (i.e. wheel cover 1000 and wheel cover 1100) include an array of connected hexagonal dimples on their outer sides, it is to be noted that embodiments of the present invention are not limited by shape of the unit forming the array. In other words, instead of array of connected hexagonal dimples, other embodiments of the invention may include array of connected circular dimples or connected triangular dimples or any other connected polygonal dimples.

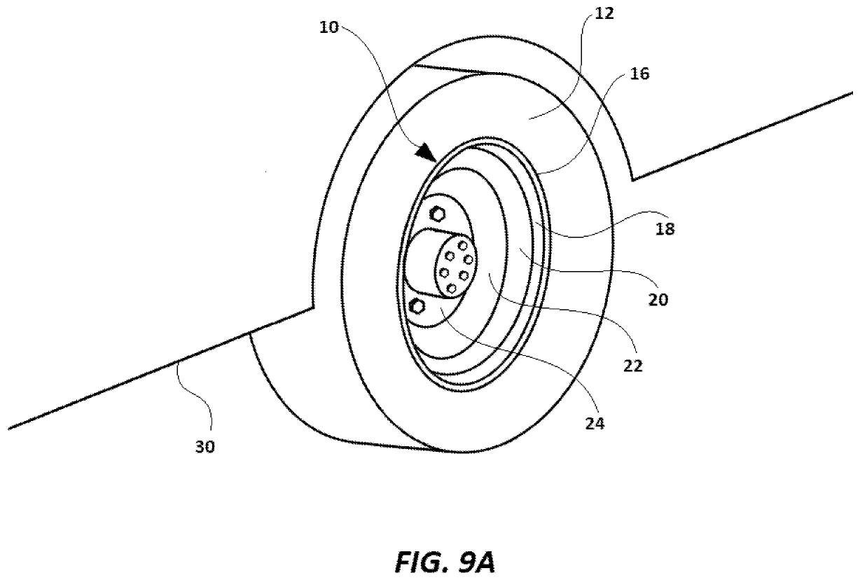

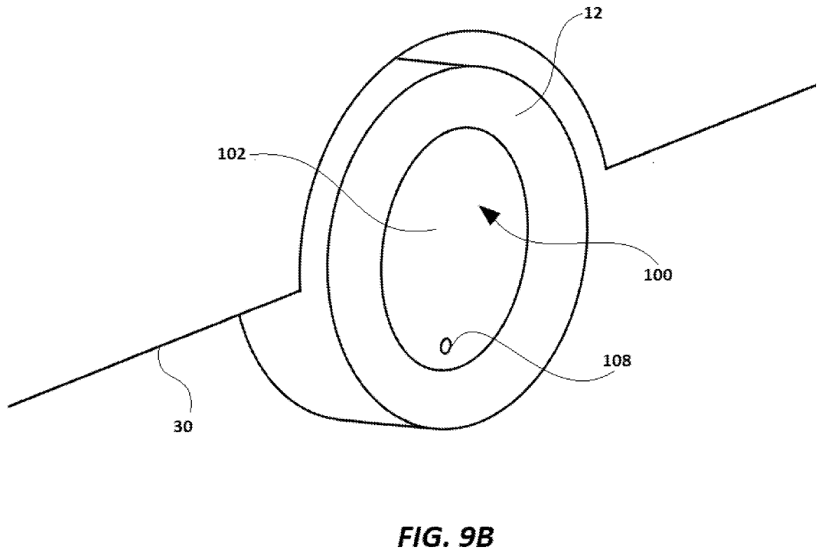

FIG. 9A illustrates a bare wheel 10 carrying a tire 12 assembled in a large commercial vehicle trailer 30, FIG. 9B illustrates the wheel 10 carrying a tire 12 of FIG. 9A having the wheel cover 100 installed over it. Though the installation of embodiments of wheel cover of the invention as described herein above have been done on bare wheel 10, it is to be understood that, embodiments of wheel cover of the invention can well be installed on wheel 10 carrying tire 12 (either inflated or in deflated state) with same ease and efforts.

It is to be noted that the magnets (whether annular magnets, bar magnets or arc magnets) used in the embodiments of invention described hereinabove can be made of iron, steel (or other iron alloys), rare earth elements or alloys, ceramic (or ferrite) magnets, made of a sintered composite of powdered iron oxide and barium/strontium carbonate ceramic, and/or an AlNiCo magnet. The alloys can include one or more of: Nd2Fe14B (neodymium, preferably), SmCo5, SmCo7, SmFe7, SmCu7 and SmZr7. Magnets can also be injection-molded magnets which are a composite of various types of resin and magnetic powders, or polymeric; e.g., using a high-coercivity ferromagnetic compound (usually ferric oxide) mixed with a plastic binder.

It is to be understood that the provisions of access holes (or retrieval notches) in embodiments is based on requirements, and scope of the present invention is not limited by presence or absence of these in embodiments of the invention. It is to be understood that dimensions of wheel cover and its components may be selectively chosen as per requirements. All such obvious variations in embodiment of the present invention are fully covered within the scope of present invention.

What is claimed is:

1. A wheel cover comprising:
an outer side;
an inner side; and
a magnetic component, wherein said magnetic component is structured to magnetically attach to a corresponding portion of a metallic wheel.

2. The wheel cover of claim 1, wherein said magnetic component is fixed on the inner side.

3. The wheel cover of claim 2, wherein said magnetic component comprises an annular magnet.

4. The wheel cover of claim 2, wherein said arc shaped magnets are arranged to form a circular array and wherein radius of said arc shaped magnets is equal to the radius of circle of said circular array.

5. The wheel cover of claim 1, which is metallic.

6. The wheel cover of claim 1, wherein said magnetic component is covered by a flexible shell portion of the wheel cover.

7. The wheel cover of claim 4, having a convex cover with a surface, said convex cover surface bearing an array of connected hexagonal dimples, or an array of connected circular dimples.

8. The wheel cover of claim 7, wherein diameter of a circle circumscribing each hexagon of the array is equal to 1/90^{th} of diameter of rim of the metallic wheel, and depth of each dimple is equal to 1/2250^{th} of diameter of rim of the metallic wheel.

9. The wheel cover of claim 1, wherein the wheel cover further includes an access hole or notch.

10. A process of reducing air friction and saving fuel, comprising driving a first vehicle equipped with the wheel cover of claim 8 on one or more of its wheels, or on a wheel of any vehicle towed by the first vehicle.

11. A method of reducing air friction and saving fuel, comprising driving a first vehicle equipped with the wheel cover of claim 8 on one or more of its wheels, or on a wheel of any vehicle towed by the first vehicle.
